(19) United States
(12) Patent Application Publication
(10) Pub. No.: US 2017/0314400 A1
(43) Pub. Date: Nov. 2, 2017

(54) HOLLOW BLADE BODY, INSERTION RIB, AND HOLLOW BLADE

(71) Applicant: Siemens Aktiengesellschaft, Munich (DE)

(72) Inventors: Fathi Ahmad, Kaarst (DE); Björn Buchholz, Dinslaken (DE); Ralph Gossilin, Oberhausen (DE); Daniela Koch, Essen (DE); Thorsten Mattheis, Mülheim (DE); Radan Radulovic, Bochum (DE); Marco Schüler, Potsdam (DE)

(73) Assignee: Siemens Aktiengesellschaft, Munich (DE)

(21) Appl. No.: 15/526,052

(22) PCT Filed: Oct. 19, 2015
(86) PCT No.: PCT/EP2015/074153

§ 371 Date: May 11, 2017

(30) Foreign Application Priority Data
Nov. 21, 2014 (EP) 14194337.3

(51) Int. Cl. F01D 5/18; F01D 5/14

(52) U.S. Cl. CPC F01D 5/188; F01D 5/147; F05D 2220/32; F05D 2260/30; F05D 2260/20

(57) ABSTRACT

A hollow blade body for a hollow blade, has a blade wall which has a pressure side which has at least one first blade connection element on the inner side thereof, and a suction side which has at least one second blade connection element diametrically opposite to the first blade connection element on the inner side thereof, wherein the first blade connection element can be engaged with at least one first rib connection element which is arranged on a first longitudinal end of an insertion rib, and the second blade connection element can be engaged with at least one second rib connection element which is arranged on a second longitudinal end of the insertion rib facing away from the first longitudinal end in such a way that the insertion rib is fixed on the hollow blade body and effects a stiffening of the hollow blade.

### CROSS REFERENCE TO RELATED APPLICATIONS

This application is the US National Stage of International Application No. PCT/EP2015/074153 filed Oct. 19, 2015, and claims the benefit thereof. The International Application claims the benefit of European Application No. EP14194337 filed Nov. 21, 2014. All of the applications are incorporated by reference herein in their entirety.

### FIELD OF INVENTION

The invention relates to a hollow blade for a turbomachine.

### BACKGROUND OF INVENTION

A turbomachine has a flow duct which is bounded radially inwardly by a shaft and radially outwardly by a casing. The turbomachine has rotor blades which are secured to the shaft and rotate with the shaft during operation of the turbomachine, and stator blades which are secured to the casing and are stationary. In particular in the turbine section of a gas turbine, the blades are exposed to a high temperature, which can reduce the service life of the blades. For example, the high temperature can cause deformation of the blades.

In order to keep the temperature of the blades low, it is conventional to remove heat from the blades by providing the blades internally with a cavity through which cooling air is made to flow. If the wall thickness of the blades is too great, this disadvantageously leads to a high temperature of the blades. If, however, the wall thickness is too small, this disadvantageously leads to inadequate strength of the blades.

In order to cool the turbine blades, use is frequently made of plates in the interior of the blades. The plates are provided with holes and therefore serve as impingement cooling plates in order to be able to cool the blade walls sufficiently and efficiently. To that end, documents U.S. Pat. No. 4,063,851 A1, EP 0 032 646 A1 and EP 2 573 325 A1 disclose a great variety of constructions, wherein in each one of the solutions presented therein the impingement cooling plates take on just a cooling function. They have no other function.

### SUMMARY OF INVENTION

The invention has the object of providing a high-strength hollow blade for a turbomachine, by means of which blade it is possible to achieve a low temperature of the hollow blade during operation of the turbomachine.

The inventive hollow blade body for a hollow blade has a blade wall with a pressure side which has, on its inner side, at least one first blade connection element, and with a suction side which has, on its inner side, at least one second blade connection element opposite the first blade connection element, wherein the first blade connection element can be brought into engagement with at least one first rib connection element arranged at a first longitudinal end of an insertion rib, and the second blade connection element can be brought into engagement with at least one second rib connection element arranged at a second longitudinal end, opposite the first longitudinal end, of the insertion rib, such that the insertion rib is secured on the hollow blade body such that it can be loaded in tension, in order that it can thus stiffen the hollow blade.

The inventive insertion rib for a hollow blade has at least one first rib connection element which is arranged at at least one first longitudinal end of the insertion rib, and has a second rib connection element which is arranged at a second longitudinal end, opposite the first longitudinal end, of the insertion rib, wherein the first rib connection element can be brought into engagement with at least one first blade connection element arranged on the inner side of a pressure side of a blade wall of a hollow blade body, and the second rib connection element can be brought into engagement with at least one second blade connection element arranged on the inner side of a suction side of the blade wall, opposite the first blade connection element, such that the insertion rib is secured on the hollow blade body and such a stiffening of the hollow blade reduces buckling.

Advantageously, the insertion rib is interlocked with the blade hollow body.

The inventive hollow blade for a turbomachine has the hollow blade body and the insertion rib, wherein the first blade connection element is in engagement with the first rib connection element and the second blade connection element is in engagement with the second rib connection element such that the insertion rib is secured to the hollow blade body and stiffens the hollow blade with respect to tensile loading.

By stiffening the hollow blade with the insertion rib, it is advantageously possible to achieve a high-strength blade even with thin blade walls. Thus, and because in operation the low thickness makes it possible to achieve low temperatures for the hollow blade, the hollow blade has a long service life. Furthermore, the insertion rib can be made of a different, more cost-effective material then the hollow blade body, and as a result the hollow blade is advantageously cost-effective. The provision of the insertion rib increases the internal surface area of the hollow blade, and as a result more heat can be removed by a cooling fluid flowing in the hollow blade than would be the case without provision of the insertion rib. The hollow blade body and the insertion rib are produced in separate production processes, thus permitting a more complex geometry of the insertion rib than would be the case if the insertion rib were cast together with the hollow blade body in a single process step.

It is advantageous that at least one of the blade connection elements has at least one blade wall groove introduced into the blade wall. At least one of the blade connection elements advantageously has at least one blade projection projecting from the blade wall. The blade wall groove and the blade projection make it possible for the insertion rib to be introduced into the hollow blade body for example simply by pushing.

It is advantageous that the first and second blade connection elements each have a blade projection which projects from the blade wall and, with the blade wall, bounds a groove, wherein one of the two grooves is open toward the leading edge of the hollow blade body, and the other of the two grooves is open toward the trailing edge of the hollow blade body, such that a rotational movement of the insertion rib allows the rib connection elements to be brought into engagement with the blade connection elements. The insertion rib advantageously has an axis of rotation and the first and second rib connection elements advantageously each have a rib projection, wherein, when the insertion rib is rotated about the axis of rotation in a direction of rotation, the rib projections project from the insertion rib in their direction of rotation, such that the rotation allows the rib projections to be brought into locking engagement with grooves of the blade connection elements. The rotation then allows the insertion rib itself to be brought into engagement with the hollow blade body, if the separation between the pressure side and the suction side varies along the blade height, as a result of which the insertion rib cannot be pushed.

The hollow blade body advantageously has a blade rib extending from the pressure side to the suction side such that, within the hollow blade body, there are formed a leading-edge channel in the region of the leading edge of the hollow blade body and a trailing-edge channel in the region of the trailing edge, wherein the blade connection elements are arranged in the leading-edge channel. During operation of the turbomachine, the leading edge of the hollow blade can buckle. Providing the insertion rib in the leading-edge channel stiffens the leading edge and thus advantageously prevents buckling of the leading edge.

It is advantageous that the insertion rib has at least two transverse webs which are securely connected to one another and are arranged next to one another in the direction from the leading edge to the trailing edge of the hollow blade, wherein at least one of the rib connection elements is arranged at each longitudinal end of the transverse webs. By virtue of the fact that the at least two transverse webs are each provided with two rib connection elements, the preferred insertion rib has at least four rib connection elements which are in locking engagement with at least four corresponding blade connection elements. This makes it possible to bring about particularly strong stiffening of the hollow blade.

The insertion rib is advantageously produced by a casting process, by bending a sheet material, by selective laser sintering and/or selective laser melting. In the case of selective laser sintering and selective laser melting, it is advantageously possible to obtain small production tolerances and a complex geometry. Bending of a sheet material is advantageously a simple production process.

It is advantageous that the blade connection elements in engagement with the rib connection elements form an angle connection, a dovetail connection, a toothed connection and/or an omega connection. These connections are advantageously hook-like, solid connections which do not come loose during operation of the turbomachine. The hollow blade advantageously has a baffle plate which has a plurality of holes and is arranged within the hollow blade such that, via the holes, a cooling fluid can be made to flow against the surface of the insertion rib. It is thus possible to use impingement cooling to cool a large surface area of the hollow blade.

### BRIEF DESCRIPTION OF THE DRAWINGS

The invention will be explained in more detail below, with reference to the appended schematic drawings. In the drawings:

FIG. 1 shows a hollow blade with a first insertion rib,

FIG. 2 shows a hollow blade with a second insertion rib,

FIG. 3 shows a hollow blade with a third insertion rib,

FIG. 4 is a detail of FIG. 3,

FIG. 5 is a detail of a hollow blade having a fourth insertion rib,

FIG. 6 is a detail of a hollow blade having a fifth insertion rib,

FIG. 7 is a detail of a hollow blade having a sixth insertion rib, and

FIG. 8 is a detail of a hollow blade having a seventh insertion rib.

### DETAILED DESCRIPTION OF INVENTION

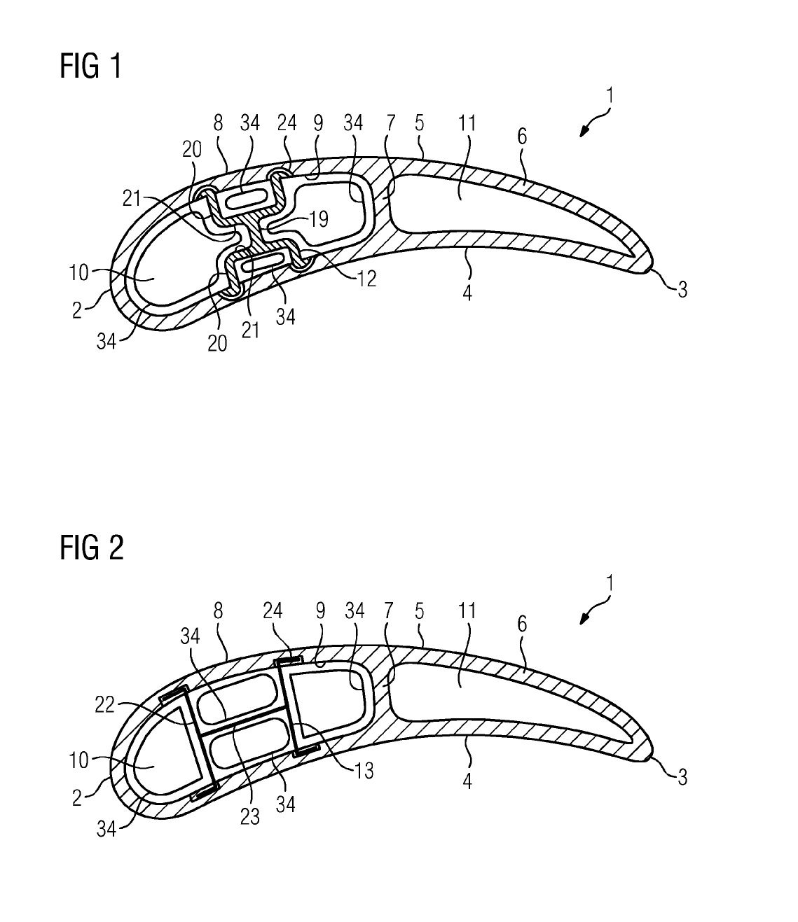

As shown in FIGS. 1 to 3, a hollow blade 1 has a hollow blade body and an insertion rib. The hollow blade body has a blade wall 6 with an outer side 8 and an inner side 9. The inner side 9 bounds an internal cavity of the hollow blade body. During operation of a turbomachine in which the hollow blade 1 is installed, the outer side 8 is exposed to a flow of a working fluid of the turbomachine. The hollow blade body also has a leading edge 2 pointing in the upstream direction of the working fluid, and a trailing edge 3 pointing in the downstream direction of the working fluid. The hollow blade body also has a pressure side 4 and a suction side 5.

The hollow blade body has a blade rib 7 which extends from the pressure side 4 to the suction side 5, such that the cavity of the hollow blade 1 is divided into a leading-edge channel 10 arranged in the region of the leading edge 2, and a trailing-edge channel 11 arranged in the region of the trailing edge 3.

The hollow blade 1 of FIG. 1 has a first insertion rib 12 in its leading-edge channel 10, and the hollow blade 1 of FIG. 2 has a second insertion rib 13 in its leading-edge channel 10. To that end, the hollow blade bodies in FIGS. 1 and 2 have two blade connection elements on the pressure side 4 and two blade connection elements on the suction side 5, in the form of blade grooves 24 introduced into the blade wall 6. The blade grooves 24 extend in the direction of the blade height, such that the first insertion rib 12 and the second insertion rib 13 can be introduced into the hollow blade body by pushing in the direction of the blade height.

The first insertion rib 12 and the second insertion rib 13 have two transverse webs which are securely connected to one another and are arranged next to one another in the direction from the leading edge 2 to the trailing edge 3 of the hollow blade 1, wherein at least one of the rib connection elements is arranged at each longitudinal end of the transverse webs. The rib connection elements each have a projection that projects from the respective transverse web. The rib connection elements are in each case in engagement with one of the blade wall grooves 24, and are loaded in tension when, due to thermal effects, the blade walls tend to move apart from one another. This configuration means that insertion ribs which can be loaded in tension prevent buckling of the blade walls.

The first transverse web as shown in FIG. 1 is formed by a first end transverse web 20, at one end of which is arranged one of the rib connection elements in engagement with the suction side 5, and at the other end of which is securely attached a first longitudinal web 21, by a second end transverse web 20, at one end of which is arranged one of the rib connection elements in engagement with the pressure side 4, and at the other end of which is securely attached a second longitudinal web 21, and by a middle transverse web 19, at the longitudinal ends of which the first and second longitudinal webs 21 are securely attached. The second transverse web 24 as shown in FIG. 2 is formed by a third end transverse web 20, at one end of which is arranged the other of the rib connection elements in engagement with the suction side 5, and at the other longitudinal end of which is securely attached the first longitudinal transverse web, by a fourth end transverse web 20, at one end of which is arranged the other of the rib connection elements in engagement with the pressure side 4, and at the other end of which is securely attached the second longitudinal transverse web 21, and by the middle transverse web 19.

The two transverse webs shown in FIG. 2 are formed by a first transverse web 22 and a second transverse web 22. The second insertion rib 13 also has a longitudinal web 23 whose longitudinal ends are securely connected to the first transverse web 22 and the second transverse web 22. As shown in FIGS. 1 and 2, both of the leading-edge channels 10 are split, by the respective insertion rib 12, 13, into four part channels. An annular baffle plate 34 with a plurality of holes in each case is introduced into each one of the part channels such that all of the internal surfaces of the hollow blades 1 can be provided with a normal incident flow of a cooling fluid that is inside the annular baffle plates 34.

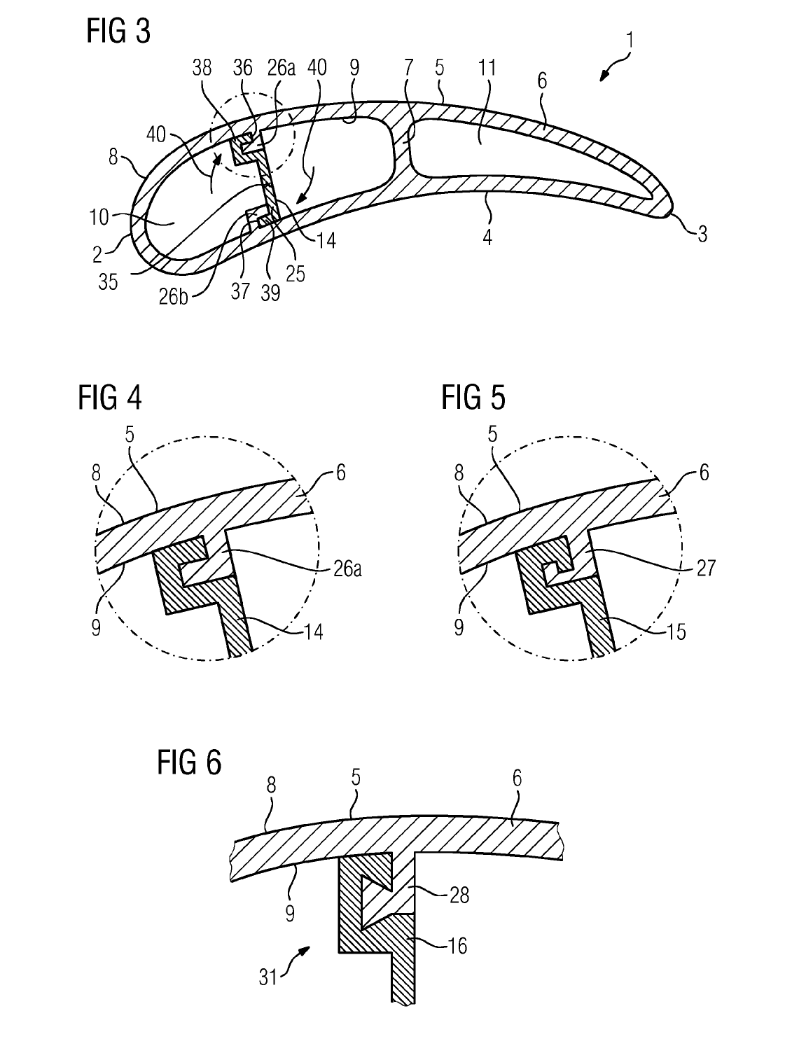

The hollow blade body shown in FIG. 3 has, as blade connection elements, a first blade projection 26a fixed to the suction side 5, and a second blade projection 26b affixed to the pressure side 4. The first blade projection 26a bounds, with the suction-side blade wall 6, a first groove 36, and the second blade projection 26b bounds, with the pressure-side blade wall 6, a second groove 37. The first groove 36 is open toward the leading edge 2 and the second groove 37 is open toward the trailing edge 3. The hollow blade 1 shown in FIG. 3 has a third insertion rib 14 which has a transverse web 25 and, as rib connection elements, a first rib projection 38 and a second rib projection 39. The first rib projection 38 projects from the third insertion rib 14 in the direction of the trailing edge 3, and the second rib projection 39 projects from the third insertion rib 14 in the direction of the leading edge 2. The effect of this is that, by rotating the third insertion rib 14 about an axis of rotation 35 in a rotation direction 40, the first rib projection 38 can be brought into engagement with the first groove 36 and, simultaneously, the second rib projection 39 can be brought into engagement with the second groove 37.

FIG. 4 shows, in an enlarged view, the first blade projection 26a and the first rib projection 38 from FIG. 3. The first blade projection 26a forms, together with the first rib projection 38, an angle connection. To that end, the first blade projection 26a is in the form of a right angle that the third insertion rib 14 grips around. FIG. 5 shows a hollow blade 1 with a fourth insertion rib 15 which is in engagement with a third blade projection 27 projecting from the blade wall 6. The fourth insertion rib 15 also forms an angle connection with the third blade projection 27. This differs from the angle connection shown in FIG. 4 in that the third blade projection 27 has another right angle at the free end of the right angle, such that the third blade projection 27 has a groove which is open toward the blade wall 6 and in which the fourth insertion rib 15 engages.

FIG. 6 shows a hollow blade 1 with a fifth insertion rib 16. As blade connection element, the hollow blade body has a fourth blade projection 28 and, as rib connection element, the fifth insertion rib 16 has a dovetail-shaped groove, which together form a dovetail connection. To that end, the fourth blade projection 28 has a dovetail which engages in the dovetail-shaped groove of the fifth insertion rib 16. In that context, it is equally conceivable that the fifth insertion rib 16 has a dovetail that engages in a groove of the hollow blade body.

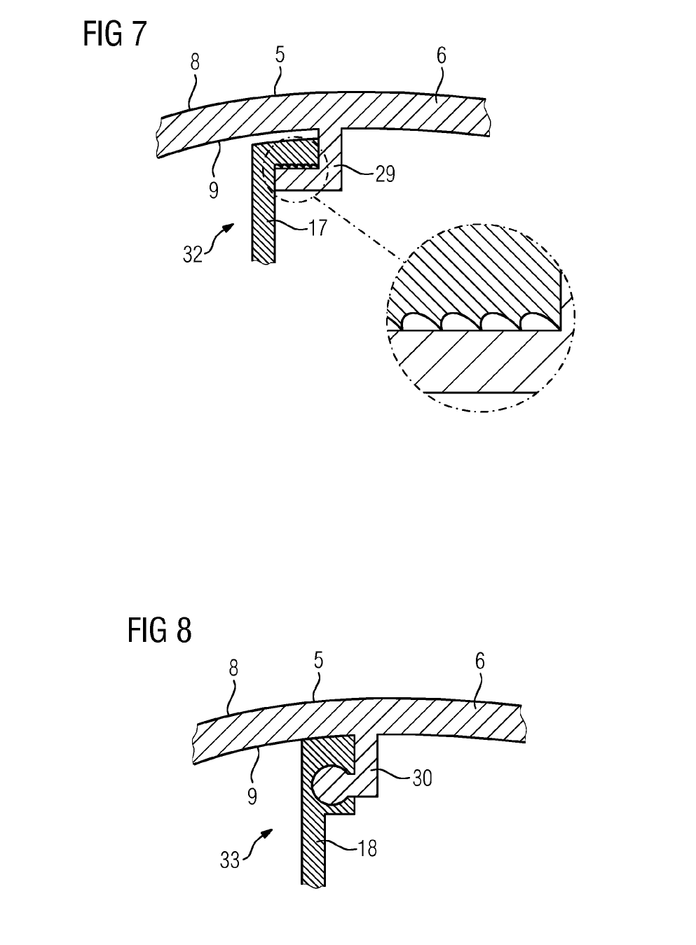

FIG. 7 shows a hollow blade 1 with a sixth insertion rib 17. As blade connection element, the hollow blade body has a fifth blade projection 29 which is in the form of a right angle and which has teeth arranged on its surface facing the inner side 9. As rib connection element, the sixth insertion rib 17 has a projection on which teeth are also arranged. The teeth of the sixth insertion rib 17 and the teeth of the fifth blade projection 29 engage in one another and thus form a toothed connection. The teeth of the sixth insertion rib 17 and of the fifth blade projection 29 are shaped such that, when in engagement, a relative movement of the sixth insertion rib 17 and of the fifth blade projection 29 in a direction from the pressure side 4 to the suction side 5 is not possible. At the same time, a relative movement in the direction from the leading edge 2 to the trailing edge 3 is permitted, such that the teeth can be brought into engagement. Preventing relative movement from the pressure side to the suction side means that a gap can be formed between the sixth insertion rib 17 and the blade wall 6.

FIG. 8 shows a hollow blade 1 with a seventh insertion rib 18. As blade connection element, the hollow blade body has a sixth blade projection 30 and, as rib connection element, the seventh insertion rib 18 has a groove, which together form an omega connection. To that end, the sixth blade projection 30 is in the form of a right angle with a bulge formed at its free end. The bulge engages in the groove of the seventh insertion rib 18. In that context, it is equally conceivable that the seventh insertion rib 18 has, at its end, a bulge that engages in a groove of the hollow blade body.

Although the invention has been described and illustrated in detail by way of the preferred exemplary embodiments, the invention is not restricted by the disclosed examples and other variations can be derived herefrom by a person skilled in the art without departing from the scope of protection of the invention.

1. A hollow blade body for a hollow blade, comprising:
a blade wall with a pressure side which has, on its inner side, at least one first blade connection element, and with a suction side which has, on its inner side, at least one second blade connection element opposite the first blade connection element,
wherein the first blade connection element is engageable with at least one first rib connection element arranged at a first longitudinal end of an insertion rib, and the second blade connection element is engageable with at least one second rib connection element arranged at a second longitudinal end, opposite the first longitudinal end, of the insertion rib, such that the insertion rib is secured on the hollow blade body such that it is loadable in tension, in order that it can thus stiffen the hollow blade.

2. The hollow blade body as claimed in claim 1,
wherein at least one of the blade connection elements has at least one blade wall groove introduced into the blade wall.

3. The hollow blade body as claimed in claim 1,
wherein at least one of the blade connection elements has at least one blade projection projecting from the blade wall.

4. The hollow blade body as claimed in claim 3,
wherein the first and second blade connection elements each have a blade projection which projects from the blade wall and, with the blade wall, bounds a groove,
wherein one of the two grooves is open toward the leading edge of the hollow blade body, and the other of the two grooves is open toward the trailing edge of the hollow blade body, such that a rotational movement of the insertion rib allows the rib connection elements to be brought into engagement with the blade connection elements.

5. The hollow blade body as claimed in claim 1,
wherein the hollow blade body has a blade rib extending from the pressure side to the suction side such that, within the hollow blade body, there are formed a leading-edge channel in the region of the leading edge of the hollow blade body and a trailing-edge channel in the region of the trailing edge, wherein the blade connection elements are arranged in the leading-edge channel.

6. An insertion rib for a hollow blade, comprising:
at least one first rib connection element which is arranged at at least one first longitudinal end of the insertion rib, and with a second rib connection element which is arranged at a second longitudinal end, opposite the first longitudinal end, of the insertion rib,
wherein the first rib connection element is engageable with at least one first blade connection element arranged on the inner side of a pressure side of a blade wall of a hollow blade body, and the second rib connection element can is engageable with at least one second blade connection element arranged on the inner side of a suction side of the blade wall, opposite the first blade connection element, such that the insertion rib is secured on the hollow blade body and stiffens the hollow blade.

7. The insertion rib as claimed in claim 6,
wherein the insertion rib has an axis of rotation and the first and second rib connection elements each have a rib projection,
wherein, when the insertion rib is rotated about the axis of rotation in a direction of rotation, the rib projections project from the insertion rib in their direction of rotation, such that the rotation allows the rib projections to be brought into engagement with grooves of the blade connection elements.

8. The insertion rib as claimed in claim 6,
wherein the insertion rib has at least two transverse webs which are securely connected to one another and are arranged next to one another in the direction from the leading edge to the trailing edge of the hollow blade, wherein at least one of the rib connection elements is arranged at each longitudinal end of the transverse webs.

9. The insertion rib as claimed in claim 6,
wherein the insertion rib is produced by a casting process, by bending a sheet material, by selective laser sintering and/or selective laser melting.

10. A hollow blade for a turbomachine, comprising
a hollow blade body as claimed in claim 1,
an insertion rib for the hollow blade body, the insertion rib comprising,
at least one first rib connection element which is arranged at at least one first longitudinal end of the insertion rib, and with a second rib connection element which is arranged at a second longitudinal end, opposite the first longitudinal end, of the insertion rib,
wherein the first rib connection element is engageable with at least one first blade connection element arranged on the inner side of a pressure side of a blade wall of a hollow blade body, and the second rib connection element can is engageable with at least one second blade connection element arranged on the inner side of a suction side of the blade wall, opposite the first blade connection element, such that the insertion rib is secured on the hollow blade body and stiffens the hollow blade,
wherein the first blade connection element is in engagement with the first rib connection element and the second blade connection element is in engagement with the second rib connection element such that the insertion rib is secured to the hollow blade body and stiffens the hollow blade.

11. The hollow blade as claimed in claim 10,
wherein the blade connection elements in engagement with the rib connection elements form an angle connection, a dovetail connection, a toothed connection and/or an omega connection.

12. The hollow blade as claimed in claim 10,
wherein the hollow blade has a baffle plate which has a plurality of holes and is arranged within the hollow blade such that, via the holes, a cooling fluid can be made to flow against the surface of the insertion rib.
